(19) United States
(12) Patent Application Publication
(10) Pub. No.: US 2026/0161569 A1
(43) Pub. Date: Jun. 11, 2026

(54) APPARATUS AND METHODS FOR MEMORY PAGE TRANSLATIONS WITHIN DIE ARCHITECTURES

(71) Applicant: QUALCOMM INCORPORATED, San Diego, CA (US)

(72) Inventors: Vishal BHUSHAN, Patiala (IN); Vasantha Kumar Bandur PUTTAPPA, Bangalore (IN)

(21) Appl. No.: 18/975,288

(22) Filed: Dec. 10, 2024

(51) Int. Cl. G06F 12/1045; G06F 12/1009

(52) U.S. Cl. CPC G06F 12/1045; G06F 12/1009; G06F 2212/651

(57) ABSTRACT

Methods and apparatuses directed to die solutions that reduce memory access latencies. In one example, a die includes translation control logic, and memory address translation logic electrically coupled to the translation control logic. The translation control logic receives a virtual memory address for virtual to physical address translation from a requesting device. The translation control logic transmits an address translation request to the memory address translation logic, where the address translation request includes the virtual memory address. Based on the virtual memory address, the memory address translation logic reads one or more translation tables to perform one or more memory address translations. Based on the translations, the memory address translation logic generates a physical memory address. The memory address translation logic then transmits the physical memory address to the translation control logic. The translation control logic transmits the physical memory address to the requesting device.

### BACKGROUND

### Field of the Disclosure

This disclosure relates generally to die architectures and, more particularly, to memory translation mechanisms within die architectures.

### Description of Related Art

Dies, such as chiplets and system-on-chips (SoCs), are used across a multitude of applications, such as telecommunication, automotive, cloud-based, gaming, enterprise, and networking applications, among various other applications. Die architectures may employ memory translation mechanisms that allow for the transfer of data, such as the transfer of data between dies. For example, a first die may need to access memory of a second die. To access the memory, the first die may have to translate a virtual memory address to a physical memory address of the memory, which can include multiple memory page translations (e.g., three memory stage translations), each page translation introducing latency into for the memory access. Moreover, such memory accesses may be slowed by long memory paths between the first die and the memory on the second die. As such, there are opportunities to address deficiencies within memory access mechanisms between dies in die architectures.

### SUMMARY

According to one aspect, a die includes translation control logic and memory address translation logic electrically coupled to the translation control logic. The memory address translation logic is configured to receive an address translation request comprising a virtual memory address from the translation control logic. Further, the memory address translation logic configured to read a memory address from a translation table based on the virtual memory address. The memory address translation logic is also configured to transmit the memory address to the translation control logic.

According to another aspect, a die includes a memory device and at least one processor electrically coupled to the memory device. The at least one processor is configured to receive an address translation request comprising a virtual memory address. Further, the at least one processor is configured to read a memory address from a translation table stored in the memory device based on the virtual memory address. The at least one processor is also configured to transmit the memory address in response to the address translation request.

According to yet another aspect, a system-on-chip (SoC) includes first memory address translation logic. The SoC also includes memory management logic electrically coupled to the first memory address translation logic. The first memory address translation logic is configured to receive, from the memory management logic, a first address translation request comprising a virtual memory address. Further, the first memory address translation logic is configured to read a first memory address from a first translation table based on the virtual memory address. The first memory address translation logic is also configured transmit the first memory address to the memory management logic. In addition, the memory management logic is configured to generate a physical memory address based on the first memory address.

### BRIEF DESCRIPTION OF DRAWINGS

FIG. 1 is a block diagram of integrated circuit package, according to some implementations;

FIG. 2 is a block diagram of a die package, according to some implementations;

FIG. 3A is a block diagram of memory address translation logic, according to some implementations;

FIGS. 3B and 3C illustrate memory address translations by the memory address translation logic of FIG. 3A, according to some implementations;

FIG. 4 is a block diagram of a die package, according to some implementations;

FIG. 5 is a block diagram of memory address translation logic, according to some implementations;

FIGS. 6A, 6B, and 6C illustrate exemplary memory messaging mechanisms, according to some implementations;

FIG. 7 is a flowchart of an exemplary memory address translation process, according to some implementations;

FIG. 8A illustrates conventional memory translation; and

FIG. 8B illustrates an exemplary memory translation, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein are directed to die solutions that reduce memory access latencies. For example, in multi-die circuits, memory resources are often shared across multiple dies. For instance, a device located on one die may need to access memory located on another die. To access the memory, the initial die may have to perform multiple memory address translations (e.g., page translations, stage translations) to generate the physical address of the memory from a virtual address of the memory. These memory address translations, however, take time, thereby increasing memory access latencies and slowing die performance. As such, various applications, such as real-time applications (e.g., artificial intelligence (Al), augmented reality (AR), virtual reality (VR), and extended reality (XR) applications) and cloud-based applications (e.g., virtual machines, hypervisors, etc.) can benefit from reduced memory access latencies. The embodiments described herein may address these and other deficiencies with conventional memory access mechanisms within die architectures.

For example, the embodiments may include the addition of memory address translation logic, referred to herein as a nanowalker, within the same die (e.g., SoC) as is the memory to be accessed, or across multiple dies. The nanowalker may be positioned relatively close to the memory to be accessed or, in some examples, within the memory to be accessed. The nanowalker is configured to perform one or more page translation operations to generate a physical address to access the memory. For example, a nanowalker can perform a single stage translation, or can perform a multi-stage translation. Moreover, each nanowalker can communicate over an interface, referred to herein as a linked list stream interface (LSI), to other on-die or off-die components, such as other nanowalkers, memory management units (MMUs), and memory devices (e.g., dynamic random access memory (DRAM)). For instance, a nanowalker located in a first die may receive a virtual address from a second die over a corresponding LSI. The virtual address may be mapped to a memory located on the first die. Based on the virtual address, the nanowalker may perform one or more page translations to generate a physical address for access to an on-die memory. The nanowalker may transmit the physical address over a second LSI to the memory, to allow for access of the memory at the physical address.

In some examples, a system memory management unit (SMMU) uses one or more nanowalkers, which are placed near memory, for faster memory translations. The SMMU can communicate in real-time with clients and a single or chain of nanowalkers connected to the SMMU. The nanowalkers offload partial and/or full address translation responsibilities from SMMU and to the one or more nanowalkers. In addition, in some examples, a protocol between the SMMU and the nanowalkers, and/or between nanowalkers, allows for the transfer of requests between corresponding entities. Further, in some examples, a Low Power Double Data Rate (LPDDR) interface allows for the support of nanowalkers located in memory, such as in DDR memory devices.

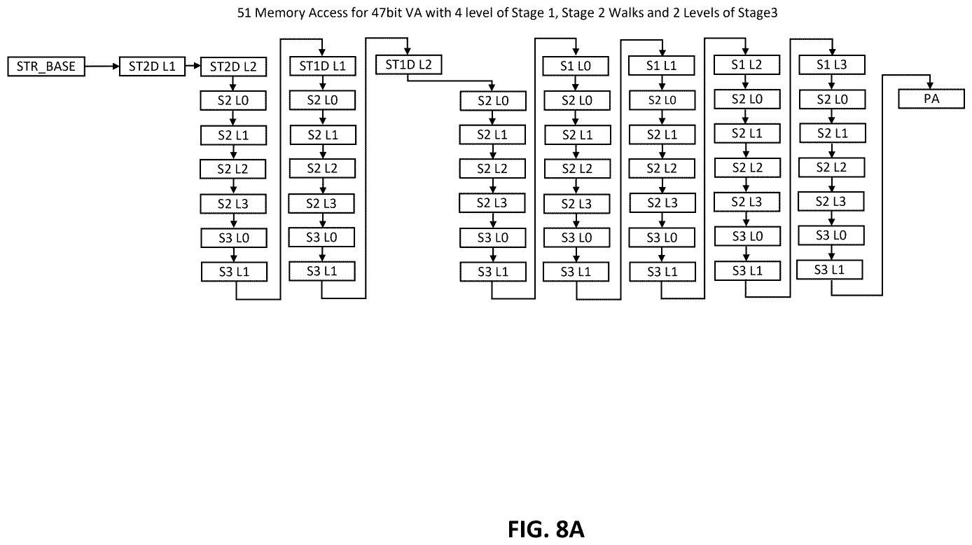

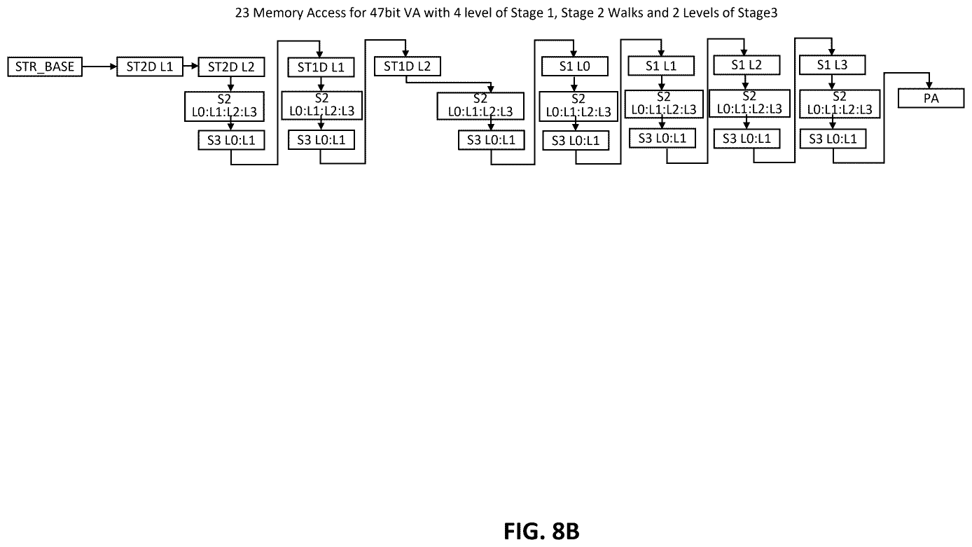

Among other benefits, the nanowalkers, which can be placed near a memory, can reduce memory access latencies, such as those experienced in multi-die solutions. For example, a memory management unit may be in communication with the real time clients, where one or more nanowalkers are electrically connected to the memory management unit. The nanowalkers offload at least partial, if not full, address translation responsibilities from the memory management unit, thereby allowing for faster virtual address to physical address memory translations. For instance, as illustrated in FIG. 8A, a forty-seven bit virtual address may require fifty-one memory accesses to generate a physical address (PA) in accordance with conventional methods (assuming accessing a base address (STR_BASE), stage one and two descriptors (ST1D, ST2D), four levels of stage one (S1) and stage two (S2) walks, and two levels of stage three (S3) walks). In at least some of the embodiments described below, this can be reduced to no more than twenty-three memory accesses to generate the physical address, as illustrated in FIG. 8B. In addition, the embodiments can include a communication protocol between devices, such as the memory management unit and the nanowalkers, or between nanowalkers themselves, which allows for the transfer of commands and requests between devices. The embodiments can also provide memory device interfaces, such as DRAM interfaces, to support nanowalkers within memory devices. Persons of ordinary skill in the art would recognize additional advantages as well.

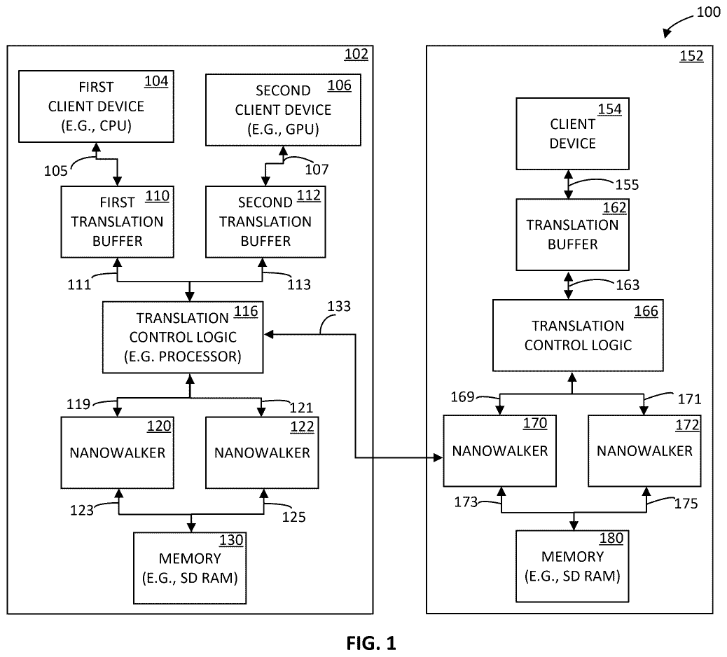

Referring now to the drawings, FIG. 1 is a block diagram of an integrated circuit package 100 (e.g., die package, SoC) that includes a first die 102 electrically coupled to a second die 152. As illustrated, the first die 102 includes a first client device 104 and a second client device 106. Each of the first client device 104 and second client device 106 can be, for example, a central processing unit (CPU), a graphical processing unit (GPU), an input/output (I/O) device, a digital signal processor (DSP), or any other suitable device. The first die 102 also includes a first translation buffer 110, a second translation buffer 112, translation control logic 116 (e.g., a translation controller), a first nanowalker 120, a second nanowalker 122, and a memory 130 (e.g., synchronous dynamic random-access (SDRAM) memory, double data rate (DDR) SDRAM, etc.).

The first client device 104 is electrically coupled over interconnect 105 to the first translation buffer 110. Similarly, the second client device 106 is electrically coupled over interconnect 107 to the second translation buffer 112. Each of the first translation buffer 110 and second translation buffer 112 may store memory page translations. For instance, each of the first translation buffer 110 and second translation buffer 112 may include cache memories (e.g., fast cache memories) that store recent memory address translations (e.g., memory address translation table). Based on a received address (e.g., virtual address), the first translation buffer 110 and second translation buffer 112 can generate a translated physical address based on memory address translations stored within their respective cache memories. For instance, based on a virtual address received in a translation request from the first client device 104, the first translation buffer 110 may, based on its stored memory address translation table, determine a corresponding physical address. For instance, the first translation buffer 110 may determine, based on a mapping of virtual to physical memory address stored within its memory address translation table, a thirty-two bit physical address for the requested virtual address. The first client device 104 may then receive the physical address from the first translation buffer 110. Similarly, based on a virtual address received in a translation request from the second client device 106, the second translation buffer 112 may, based on its stored memory address translation table, determine a corresponding physical address. In this example, the second client device 106 may then receive the physical address from the second translation buffer 112.

If, however, any one of the first translation buffer 110 and second translation buffer 112 cannot map the received virtual address to a physical address (e.g., no “hits” within their corresponding memory translation table), then the first translation buffer 110 or second translation buffer 112 may transmit a virtual address translation request to the translation control logic 116 for virtual to physical address translation. For instance, the virtual address translation request may identify a virtual memory page and a virtual memory page offset. As an example, the virtual address translation request may include a thirty-two bit virtual address where the upper twenty bits identifies (e.g., points to) the virtual memory page (e.g., the page number), and the lower twelve bits identifies an offset within the virtual memory page (e.g., page offset). As illustrated, the first translation buffer 110 is electrically coupled to the translation control logic 116 over interconnect 111. Likewise, the second translation buffer 112 is electrically coupled to the translation control logic 116 over interconnect 113. Each of the first translation buffer 110 and the second translation buffer 112 may transmit the virtual address translation request to the translation control logic 116 for virtual to physical address translation. If, however, the first translation buffer 110 and the second translation buffer 112 cannot determine memory translations based on their memory address translation tables (e.g., no “hits”), they then transmit the virtual address translation request to the translation control logic 116 for virtual to physical address translation.

Based on receiving a virtual address translation request, the translation control logic 116 can perform the virtual to physical address translation based on offloading at least part of the translation operations to one or more nanowalkers 120, 122. For instance, each of the nanowalkers 120, 122 can be configured to perform a partial memory address translation (e.g., stage one translation, a stage two translation, etc.), or a full memory address translation respectively (e.g., multiple state translations to determine a virtual to physical memory address translation). Each memory stage translation may include one or more page walks (e.g., reading of corresponding memory address translation tables). The translation control logic 116 can transmit, for example, a single stage translation request, or a full translation request, to each nanowalker 120, 122. The request can include, for instance, the virtual address (e.g., a virtual page number and offset) and a base address of a translation table for each stage translation. For instance, a single stage translation request may include the virtual address and the base address of the translation table for the single stage translation. A full translation request may include the virtual address and the base address of the translation table for each stage translation (e.g., for a three stage translation, the full translation request may include the base address of each of the three corresponding translation tables). The translation control logic 116 can transmit a first request to the first nanowalker 120 over interconnect 119, and a second request to the second nanowalker 122 over interconnect 121. In some examples, the first request may be for a portion of the memory translations required for a full translation, and the second request may be for another portion of the memory translations required for the full translation.

Based on a received request (e.g., a single stage translation request or a full translation request), the nanowalkers 120, 122 may access a corresponding translation table stored within memory 130 to determine the requested translation. For instance, for a single translation request (e.g., stage 0 translation request), nanowalkers 120, 122 may extract the virtual address and the base address of the translation table from the received single translation request. Further, the nanowalkers 120, 122 can determine a corresponding physical address to the virtual address by accessing the translation table located at the base address located in memory 130, and identifying the corresponding virtual to physical address mapping (i.e., the physical address that maps to the virtual address). Similarly, for a full translation request, nanowalkers 120, 122 may, for each of multiple stages (e.g., stage 0, stage 1, stage 2), extract the virtual address and the base address of a translation table from the received full translation request. Further, the nanowalkers 120, 122 can determine each stage's translation by accessing each stage's corresponding translation table located at its corresponding base address in memory 130. Based on completing each stage's translation, the nanowalkers 120, 122 identify the corresponding virtual to physical address mapping (i.e., the physical address that maps to the virtual address). The nanowalkers 120, 122 can then return the determined physical address (or, in some cases, intermediate address) to the translation control logic 116. Once the translation control logic 116 has determined the physical address that maps to the requested virtual address, the translation controller 116 returns the physical address to the requesting device (e.g., the first client device 104 or second client device 106). In some examples, each of the nanowalkers 120, 122 can reside within the memory 130. In other examples, each of the nanowalkers 120, 122 can reside within a memory controller.

As illustrated, the second die 152 includes client device 154, translation buffer 162, translation control logic 166, a first nanowalker 170, a second nanowalker 172, and a memory 180. Similar to as described above, the translation buffer 162 can receive, over interconnect 155, translation requests, and can store within cache memory translation entries. If the first translation buffer 162 cannot determine a memory translation based on its memory address translation table (e.g., no “hits”), then it may transmit, over interconnect 163, the translation request to the translation control logic 166 for virtual to physical address translation. Further, the translation control logic 166 can transmit a corresponding translation request (e.g., a single stage translation request, a full translation request) to one or more of the nanowalkers 170, 172 over interconnects 169, 171, respectively, to perform one or more page translations, as described herein. For instance, each of the nanowalkers 170, 172 may access memory 180 over interconnects 173, 175, respectively, to determine a single stage translation, or full stage translation, based on the request received from the translation control logic 166. Based on the page translations, the nanowalkers 170, 172 can determine at least corresponding portions of a physical address that maps to the requested virtual address. The nanowalkers 170, 172 may return the determined physical address (or, in some cases, intermediate address) to the translation control logic 166. Once the translation control logic 166 has determined the physical address that maps to the requested virtual address, the translation control logic 166 returns the physical address to the requesting device (e.g., the first client device 104 or second client device 106)

In some examples, a client device, such as the first client device 104 or the second client device 106, of the first die 102 has to access a memory device that has a corresponding translation table stored in the memory 180 of the second die 152. In these examples, the translation control logic 116 of the first die 102 transmits the translation request to the nanowalker 170 over interconnect 133. Based on the received translation request, the nanowalker 170 performs one or more page translations, as described herein, to generate a physical address for the memory 180. The nanowalker 170 generates the physical address for the memory 180, and transmit the physical address to the memory 180 over interconnect 173. Because the nanowalker 170 performs page walks or complete translations near the memory 180, overall translation latencies are reduced.

In some examples, the integrated circuit package 100 performs the following operations. The first translation buffer 110 receives a translation request from the first client device 104 over interconnect 105. The translation request includes a virtual address. The translation buffer 110 checks its internal cache memory for a virtual to physical address mapping that corresponds to the received virtual address. If there is a match (i.e., a physical address mapping available for the virtual address), the physical address is returned to the first client device 104 to access a memory location at the physical address. If, however, the internal cache memory does not have a virtual to physical address mapping for the received virtual address, the first translation buffer 110 transmits the request to the translation control logic 116 over interconnect 111. The request causes the translation control logic 116 to obtain a page descriptor from memory by performing multiple page walks.

For instance, the translation control logic 116 can include a global walker that performs page translations. The global walker scans the translation cache in the translation control logic 116 for any physical address mapping for the given virtual address. As described herein, the translation cache can store intermediate addresses or physical addresses indexed for a given virtual address. If, for the received virtual address, the translation cache includes a mapping to the final physical address, then the translation is complete and the physical address is returned to the first client device 104 for memory access. If, however, for the received virtual address there is an intermediate address available within the translation cache, then a partial translation is sent back to the global walker, and the global walker performs multiple page walks to complete the translation. In some examples, the global walker offloads the page walks to one or more nanowalkers 120, 122. For sequential walks, the global walker can offload translations in a stage-by-stage order, or can offload the translation completely to a nanowalker 120, 122. For any parallel walks, the global walker can offload parallel translations to multiple nanowalkers 120, 122 simultaneously.

A nanowalker 120, 122 performs the page table translation based on the received base addresses and virtual or intermediate address. After completion of page walks, the nanowalker 120, 122 can store the translated addresses in its local cache or, in some instances, can store the translated addresses in a centralized cache within the translation control logic 116. In some examples, the nanowalker 120, 122 returns the translated addresses to the translation control logic 116.

In some examples, when the request is a stage request (e.g., stage one request, stage two request), then the nanowalker 120, 122 can chose to issue the request for the next sequential stage to another nanowalker 120, 122, or in some instances can issue multiple parallel stage requests to multiple nanowalkers 120, 122. If the previous request was a full translation request, then the translated response can be stored in the cache and sent to the translation buffer within the translation control logic 116 or, in some examples, to the first client device 104. Although described above with respect to memory translations, the nanowalkers 120, 122 can be employed within the integrated circuit package 100 as a controller for any operations that utilize linked lists.

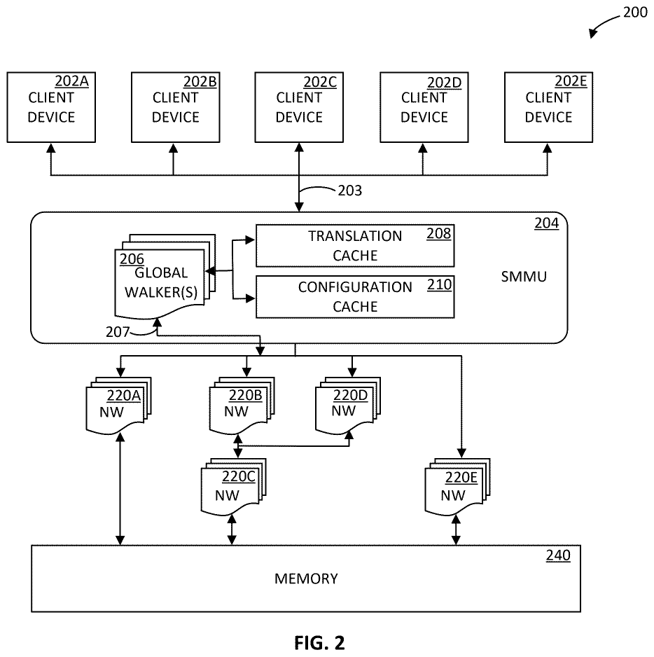

FIG. 2 is a block diagram of a die package 200 that includes multiple client devices 202 (i.e., client devices 202A, 202B, 202C, 202D, 202E), a system memory management unit (SMMU), multiple nanowalkers 220 (i.e., nanowalkers 220A, 220B, 220C, 220D, 220E), and a memory 240. The SMMU 204 further includes one or more global walkers 206, a translation cache 208, and a configuration cache 210. The translation cache 208 may store page translation tables, while the configuration cache 210 may store memory 240 configuration information.

As illustrated, the SMMU 204 can receive memory requests 203 from the various client devices 202 to access memory 240. Each memory request 203 may include a virtual address that the client devices 202 have mapped to memory 240. The SMMU 204 can include one or more global walkers 206, where each global walker 206 can perform partial or full virtual to physical address translations for a received virtual address. For example, based on receiving a memory request 203, the global walker 206 may, based on the virtual address of the memory request 203, access the translation cache 208 to determine a partial or a full translation for corresponding physical memory address. When the global walkers 206 cannot perform a full virtual to physical address translation for a received request, a global walker 206 can send a translation request 207 to a nanowalker 220, thereby offloading at least partial translation requests to the nanowalkers 220. The global walker 206 can offload the translation requests stage by stage to a nanowalker when the walks are sequential. If, however, the walks are parallel, then the global walker 206 can offload parallel stages to different nanowalkers 220 simultaneously. The nanowalkers 220 can control linked list access towards the memory 240, and can act as a generic linked list controller.

Further, the nanowalkers 220A, 220C, and 220E can generate the physical address of the memory 240 based on the request. For instance, in some examples, a global walker 206 transmits the base address of stage one and stage two page tables along with a virtual address to nanowalker 220A. Based on the base addresses and the virtual address, the nanowalker 220A performs two stage page translations and returns the physical address. As another example, the global walker 206 may offload only a single stage translation to the nanowalker 220A. Here, the global walker 206 transmits only the corresponding page table base address (e.g., the stage one table base address) and the corresponding virtual address or intermediate address to the nanowalker 220A. a global walker 206 may transmit a partial translation request 207 to one or more nanowalkers 220, where each nanowalker 220 may perform one or more stage translations (e.g., page walks).

As described herein, each nanowalker 220 may include a translation cache that stores full or intermediate page translations (e.g., three levels of stage two translations, two levels of stage three translations, etc.) for the memory 240. The nanowalkers 220 may read the translation cache to access a translation table to translate a stage base address received in the partial translation request 207 to a next stage translated address (e.g., virtual to intermediate address, intermediate to physical address). In some examples, the translation cache can be accessed to get a complete translation (e.g. virtual to physical address). In some examples, the next stage translated address generated by a nanowalker, such as nanowalker 220A and 220E, includes at least a portion of the physical address of the memory 240. In some instances, a nanowalker, such as nanowalker 220B and nanowalker 220D, generate a next stage translated address that is transmitted to another nanowalker, such as nanowalker 220C (e.g., cascaded nanowalkers 220). For example, while nanowalker 220B may perform a stage two translation, nanowalker 220C may perform a stage three translation.

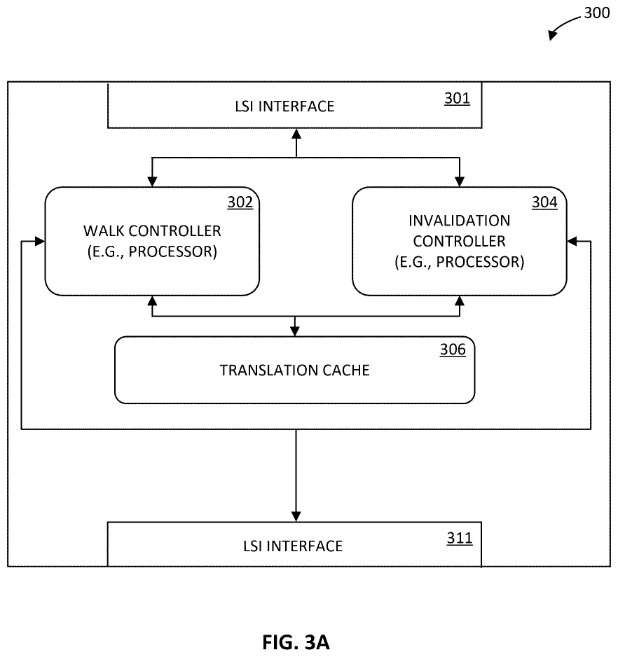

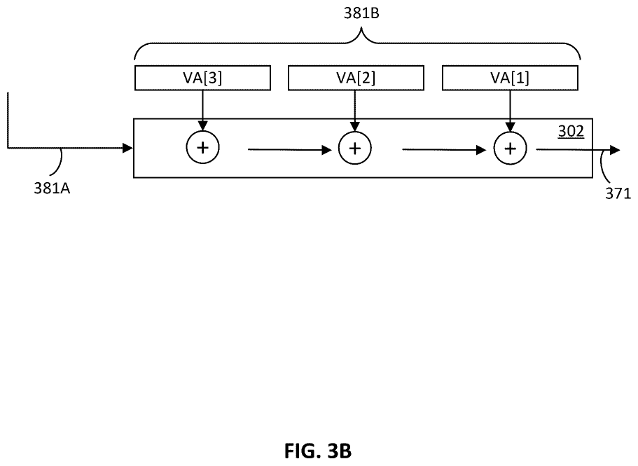

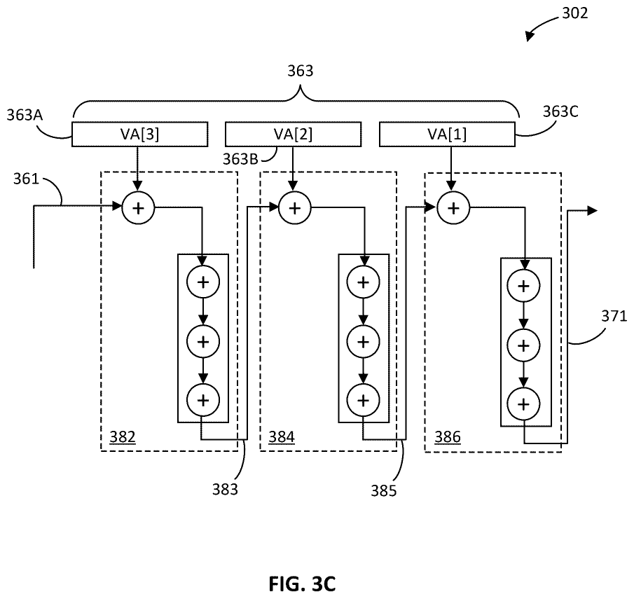

FIG. 3A illustrates an exemplary nanowalker 300 (i.e., memory address translation logic). Although described below with respect to memory translations, nanowalkers 300 can be employed as generic linked list controllers. As illustrated, the nanowalker 300 includes a walk controller 302, an invalidation controller 304, a translation cache 306, and list stream interfaces (LSIs) 301 and 311. Each of the walk controller 302 and the invalidation controller 304 may be implemented by one or more processors executing instructions, in digital logic, or other suitable logic. In addition, the translation cache 306 stores memory translations (e.g., a translation table), such as memory translations between stages (e.g., stage one to stage two translations, stage two to stage three translations, stage three to physical address translations, etc.). As described further herein, in some examples, the translation cache 306 is not needed (e.g., when the nanowalker 300 is used for translation only and only a central cache is maintained).

As described further herein, the LSI interfaces 301, 311 allow for communication with, for example, other nanowalkers 300, memory management units (e.g., SMMU 204), memory devices (e.g., memory 240), and translation controllers (e.g., translation control logic 116). For instance, the nanowalker 300 may receive a virtual address from a signal bus electrically coupled to the LSI interface 301, and may transmit a generated translated address to a signal bus (e.g., memory address bus) electrically coupled to the LSI interface 311.

The walk controller 302 can receive the virtual address from the LSI interface 301, access translation cache 306 to determine a translated address, and can transmit the translated address to the LSI interface 301. The invalidation controller 304 can receive a signal (e.g., from a memory management unit) indicating a reset of memory translations and, based on the signal, can invalidate (e.g., clear out) the translation cache 306. For example, LSI interfaces 301, 311 may support distributed virtual memory (DVM) messages, such as DVM invalidation and sync messages. A nanowalker 300 can receive a DVM invalidation message through the LSI interface 301 (e.g., from an MMU) and, in response, the invalidation controller 304 may invalidate the translation cache 306.

FIG. 3B illustrates a single stage translation that can be performed by the nanowalker 300. As illustrated, the walk controller 302 receives a base address 381A and a virtual address 381B. The base address 381A may be an address of an L0 page table, for instance. In this example, the virtual address 381B is divided into three slices of nine bits each (represented by VA[3], VA[2], and VA[1]). This may be the case, for instance, for a system that includes 4K Page Tables and a 39 bit Virtual Address. Based on the base address 381A and the virtual address 381B, an initial address of a Level 1 entry (e.g., L1 Descriptor) is generated, where a value of the Level 1 entry points to a base address of an L2 page table. Using the value defined by VA[2] as an index in the L2 page table, a base address of an L3 page table is obtained. The final physical address 371 is generated based on indexing the L3 page table at the location defined by VA[1].

FIG. 3C illustrates a multi-stage translation that can be performed by the nanowalker 300. In this example, the walk controller 302 implements various memory stage translations (e.g., stage one and stage two translations) based on a received virtual address. The walk controller 302 includes first stage logic 382, second stage logic 384, and third stage logic 386, which may correspond to L1, L2, and L3 levels of a stage one translation. In this example, the walk controller 302 receives a base address 361 of a stage one and stage two page table, and a virtual address 363 that is divided into various slices. The number of slices is dependent on the page size Here, in this example, the virtual address is divided into three slices, where a first slice 363A is defined by VA[1], a second slice 363B is defined by a VA[2], and third slice is defined by VA[3] 363C. The first stage logic 382 performs a stage two translation based on the base address 361 and the first slice 363A to generate a first intermediate address 383. The second stage logic 384 receives the first intermediate address 383 from the first stage logic 382, and performs a stage two translation based on the first intermediate address 363 and the second slice 363B to generate a second intermediate address 385. Further, the third stage logic 386 receives the second intermediate address 385 from the second stage logic 384, and performs a stage two translation based on the second intermediate address 385 and the third slice 363C to generate the physical address 371.

The second stage logic 384 receives the first intermediate address 383 from the first stage logic 382, and performs a stage two translation based on the first intermediate address 363 and the second slice 363B to generate a second intermediate address 385. Further, the third stage logic 386 receives the second intermediate address 385 from the second stage logic 384, and performs a stage two translation based on the second intermediate address 385 and the third slice 363C to generate the physical address 371. The physical address 371 can then be used to provide the address signals to a corresponding memory device.

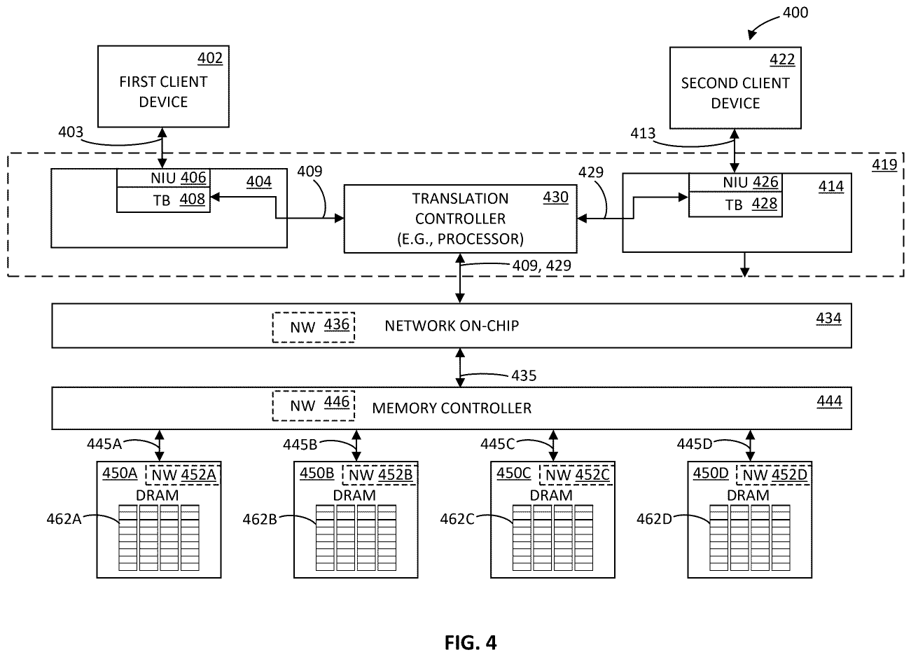

FIG. 4 illustrates a die package 400 that illustrates the optional placement of nanowalkers within different components of the die package 400. As illustrated, the die package 400 includes a first client device 402, a second client device 422, a first network device 404, a second network device 414, a translation controller 430, a network on-chip (NOC) 434, a memory controller 444, and various memories 450. In some examples, the first network device 404, second network device 414, and translation controller 430 form, or are part of, an SMMU 419. As illustrated, one or more of the NOC 434, memory controller 444, and memories 450 may include a corresponding nanowalker 436, 446, 452.

The first client device 402 is electrically coupled to a network interface unit (NIU) 406 of the first network device 404. The NIU 406 may receive a virtual address 403 from the first client device 402 to access one of the memories 450A, 450B, 450C, 450D. Based on the virtual address 403, the NIU 406 may read a translation table stored within a translation buffer 408 to determine a corresponding physical address. If the virtual address 403 cannot be translated (e.g., no “hits”), the first client device 404 will send a translation request 409 to the translation controller 430.

Similarly, the second client device 422 is electrically coupled to an NIU 426 of the second network device 414. Here, the NIU 426 may receive a virtual address 413 from the second client device 422 to access one of the memories 450A, 450B, 450C, 450D. Based on the virtual address 413, the NIU 426 may read a translation table stored within a translation buffer 428 to generate a physical address. If the translation buffer 428 does not contain an entry for the virtual address 413, the second network device 414 may then transmit a translation request 429 to the translation controller 430.

The translation controller 430 can receive the translation requests 409, 429, and can transmit the translation requests 409, 429 to the NOC 434. Each of the translation requests 409,429 can include the virtual address to be translated, and a corresponding translation table base address. In some examples, the NOC 434 includes a nanowalker 436 that performs partial or full virtual to physical memory address translations (e.g., stage one, stage two, stage three translations) based on the translation requests 409, 429. If the nanowalker 436 can perform the virtual to physical address translation, the nanowalker 436 provides the physical address back to the requesting device (e.g., the first client device 402). If, however, the nanowalker 436 cannot perform the virtual to physical address translation, or the NOC 434 does not include the nanowalker 436, the NOC 434 can transmit a translation request 435 to the memory controller 444, where the translation request 435 includes the virtual address to be translated, and the corresponding translation table base address.

In some examples, the memory controller 444 includes a nanowalker 446. The nanowalker 446 can be configured to perform a partial or full virtual to physical memory address translation based on the received translation request 435. For instance, the nanowalker 446 may access a translation table within the memory controller 444 to determine the physical address (e.g., for a full translation) that maps to the virtual address identified within the received translation request 435. If the memory controller 444 is able to generate the physical address, the memory controller 444 provides the physical address back to the requesting device (e.g., the first client device 402). If, however, the nanowalker 446 cannot determine the physical address (e.g., no “hits” in the translation table or further translations are needed), or the memory controller 444 does not include the nanowalker 446, the memory controller 444 can transmit a translation request 445 to one or more nanowalkers 452 located in the memories 450 to perform a partial of full virtual to physical address translation.

For example, the memories 450 can include a nanowalker 452 that, based on a received translation request 445, performs partial or full virtual to physical memory address translations. As illustrated, for instance, memory 450A may include a nanowalker 452A that determines, based on a received translation request 445A, either an intermediate address for a partial translation, or the physical memory address for a full translation, of the received virtual address. To determine the translated address, the nanowalker 452A may access a translation table 462A stored in the memory 450A. The memory 450A may then provide the translated address to the memory controller 444. Similarly, memory 450B may include a nanowalker 452B that accesses, based on a received translation request 445B, a translation table 462B to determine a translated address (e.g., either an intermediate address or the physical memory address). The nanowalker 452B then returns the translated address to the memory controller 444. In addition, memory 450C may include a nanowalker 452C that accesses, based on a received translation request 445C, a translation table 462C stored in memory 450C to determine a translated address. The nanowalker 452C then returns the translated address to the memory controller 444. Further, memory 450D may include a nanowalker 452D that accesses, based on a received translation request 445D, a translation table 462C stored in memory 450C to determine a translated address. The nanowalker 452D then returns the translated address to the memory controller 444, for return back to the requesting device (e.g., the first client device 402 or the second client device 422).

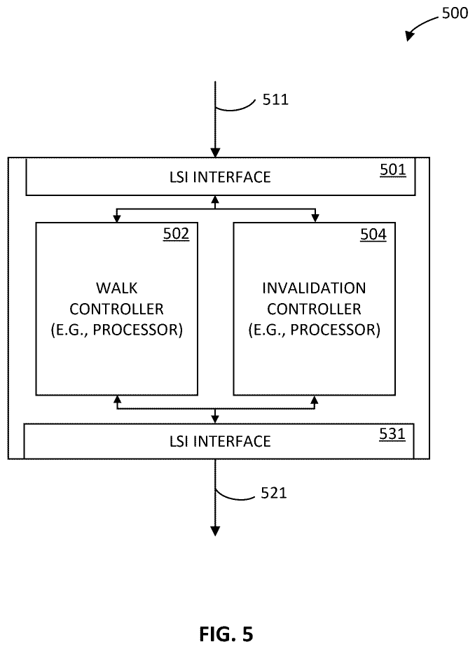

FIG. 5 illustrates a nanowalker 500 that includes LSI interfaces 501, 531, a walk controller 502, and an invalidation controller 504. Unlike the nanowalker 300 of FIG. 3, nanowalker 500 does not include a translation cache. Nanowalker 500 may be employed for single-stage page translations, for instance. The nanowalker 500 may receive, through LSI interface 501, a request 511 that includes a virtual address and a base pointer for a translation table (e.g., a base pointer to an LO page table). Based on the request 511, the walk controller 502 determines a physical address 521, and transmits the physical address 521 to the LSI interface 531. In some instances, a memory management unit or memory controller that includes a nanowalker 500 may maintain a translation cache that is read by the walk controller 502 to perform the memory address translations. The translation cache can be maintained within nanowalker 500, or as an independent device outside of the nanowalker 500. Although described with respect to memory address translations, nanowalkers 500 can be employed as generic linked list controllers.

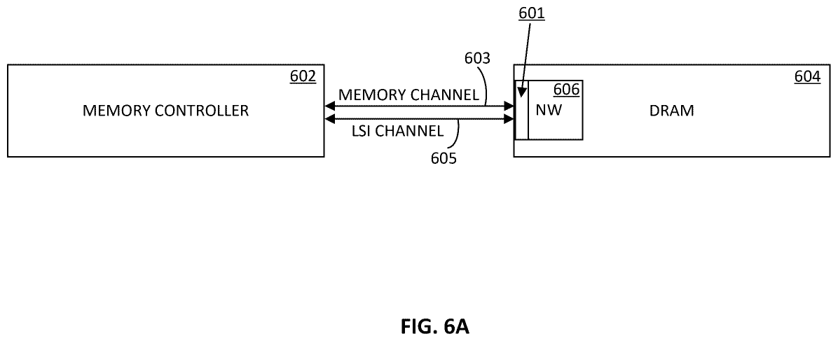

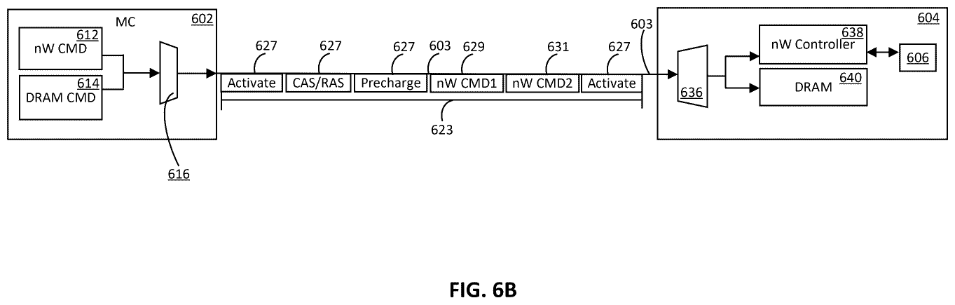

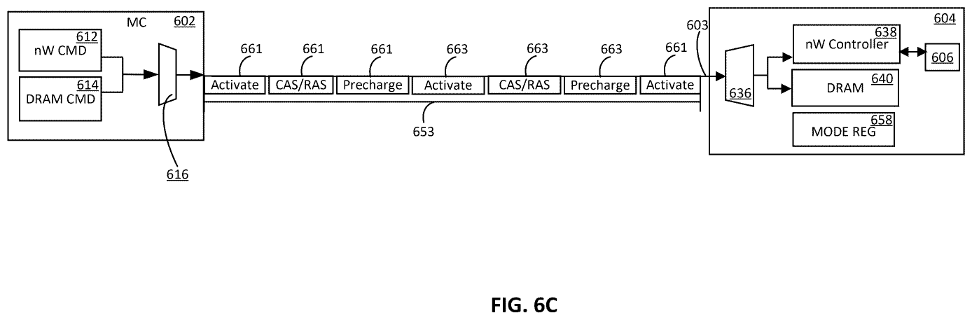

FIG. 6A illustrates a memory 604 (e.g., a Low Power Double Data Rate (LPDDR) DRAM) that includes a nanowalker 606. The memory 604 is communicatively coupled to a memory controller 602 over each of a memory channel 603 (e.g., LPDDR channel) and an LSI channel 605 of a memory bus interface. The LSI channel 605 may be configured as a side channel (e.g., serial or parallel interface channel) to the primary memory channel 603. While the memory controller 602 may transmit commands, such as DRAM commands, over the memory channel 603, the memory controller 602 can additionally transmit LSI commands over the LSI channel 605. LSI commands can include, for instance, commands to configure the walk controller and invalidation controller of the nanowalker 606, and commands to invalidate and/or sync the translation cache of the nanowalker 606, among others. For example, read commands and read data can be sent over the LSI channel 605 for address translation operations.

FIG. 6B illustrates an example where the memory controller 602 communicates LSI commands and DRAM commands to the memory 604 over the same memory channel 603 of a memory bus interface. In this example, the memory controller 602 includes nanowalker command logic 612, DRAM command logic 614, and DRAM interface logic 616. The memory 604 includes a corresponding memory controller interface 636, nanowalker control logic 638, and DRAM 640.

The nanowalker command logic 612 of the memory controller 602 can generate LSI commands for the nanowalker 606 of the memory 604, while the DRAM command logic 614 can generate DRAM commands for the DRAM 640 of the memory 604. The DRAM interface logic 616 transmits the LSI commands and the DRAM commands over the memory channel 603 of the memory bus interface. The memory controller interface 636 receives the DRAM commands and the LSI commands, and forwards them to either the nanowalker control logic 638, or the DRAM 640, for processing. Based on a received LSI command, the nanowalker control logic 638 may signal the nanowalker 606 to perform a corresponding operation, such as to invalidate or sync its translation cache.

For instance, to issue LSI commands to the nanowalker 606, unused (e.g., reserved) bits and/or commands can be used to define the nanowalker LSI commands. The memory controller interface 636 can determine, based on the bits and/or commands, whether a particular command is for the nanowalker control logic 638, or the DRAM 640. As illustrated, commands 623 to the DRAM 640 can include activate, column address strobe (CAS)/row address strobe (RAS), and precharge DRAM commands 627, and commands to the nanowalker control logic 638 can include nanowalker commands 629, 631.

FIG. 6C also illustrates an example where the memory controller 602 communicates LSI commands and DRAM commands to the memory 604 over the same memory channel 603. In this example, however, the memory 604 is configured to be in either a “DRAM” mode or a “nanowalker” mode. For instance, the memory 604 may include a mode register 658 that defines the mode of the memory. In some examples, the memory controller 602 can transmit a mode command that sets the mode of the memory 604 to either the “DRAM” mode or the “nanowalker” mode. When in “DRAM” mode, the memory 604 interprets all commands as “DRAM” commands. For instance, the memory controller 602 may transmit a mode command to set the memory 604 in DRAM mode, and may then transmit DRAM commands to the memory 604. When in “nanowalker” mode, however, the memory 604 interprets all commands as “LSI” commands for nanowalkers. For instance, the memory controller 602 may transmit a mode command to set the memory 604 in nanowalker mode, and may then transmit LSI commands for nanowalkers to the memory 604.

In some instances, a “DRAM” command causes the memory 604 to switch to the “nanowalker” mode, and an “LSI” command causes the memory 604 to switch to the “DRAM” mode. In some instances, one or more bits in the command identifies the command as a DRAM command or an LSI command for nanowalkers. For example, commands 653 transmitted to the memory 604 can include activate, CAS/RAS, and precharge DRAM commands 661, and DRAM commands 663 that include at least one bit identifying the commands as nanowalker commands.

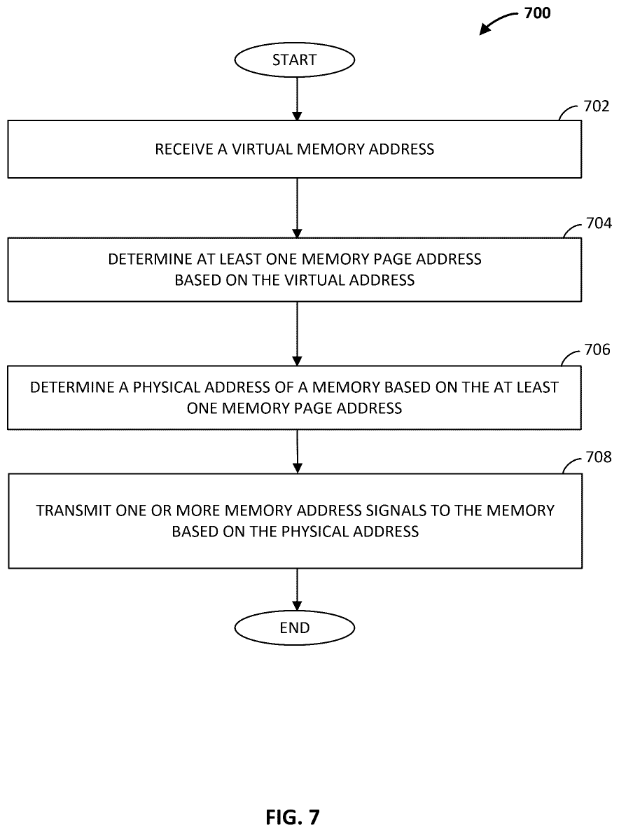

FIG. 7 is a flowchart of an exemplary memory address translation process 700 that may be carried out by any of the nanowalkers described herein (e.g., nanowalkers 120, 122, 170, 172, 220, 446).

Beginning at block 702, a virtual memory address is received. For example, the nanowalker may receive a virtual address from a memory management unit. At block 704, a memory page address translation is performed where at least one memory page address is determined based on the virtual address. The memory page address may be, for instance, a stage 1, stage 2, stage 3, or any stage “N” memory address. For example, the nanowalker may access a memory address translation table stored in translation cache to read a corresponding memory page address based on at least a portion of the virtual address, where the portion of the virtual address serves as an index to a memory location of the memory address translation table.

Proceeding to block 706, a physical address of the memory is determined based on the at least one memory page address. For instance, the nanowalker may issue multiple memory reads (i.e., page walks) to determine the physical address of the memory. At block 708, one or more memory address signals are transmitted to the memory based on the physical address. For example, the nanowalker may transmit the memory address signals (e.g., CAS/RAS signals) to allow for access of the memory at the physical address.

Implementation examples are further described in the following numbered clauses:
1. A die comprising:
translation control logic; and
memory address translation logic electrically coupled to the translation control logic, the memory address translation logic configured to:
   receive an address translation request comprising a virtual memory address from the translation control logic;
   read a memory address from a translation table based on the virtual memory address; and
   transmit the memory address to the translation control logic.
2. The die of clause 1, wherein the memory address translation logic is configured to read the translation table from a memory device.
3. The die of clause 2, wherein the memory address translation logic is configured to:
receive an invalidation command; and
invalidate a cache of the memory device based on receiving the invalidation command, wherein the translation table is stored in the cache.
4. The die of any of clauses 2-3, wherein the translation control logic is positioned between the memory address translation logic and the memory device.
5. The die of any of clauses 1-4, wherein the memory address is a physical memory address of a device.
6. The die of any of clauses 1-5, wherein the memory address is of a memory page table.
7. The die of any of clauses 1-6, wherein the memory address translation logic is configured to:
extract, from the address translation request, a memory page address and a memory page offset value; and
determine the memory address for the translation table based on the memory page address and the memory page offset value.
8. The die of any of clauses 1-7, wherein the translation control logic is configured to receive the address translation request from a client device, and transmit the memory address to the client device.
9. The die of any of clauses 1-8, wherein the translation control logic is configured to:
receive the memory address from the memory address translation logic;
read a second memory address from a second translation table based on the memory address; and
transmit the second memory address to a client device.
10. A die comprising:
a memory device; and
at least one processor electrically coupled to the memory device, the at least one processor configured to:
   receive an address translation request comprising a virtual memory address;
   read a memory address from a translation table stored in the memory device based on the virtual memory address; and
   transmit the memory address in response to the address translation request.
11. The die of clause 10, wherein the at least one processor is configured to:
receive an invalidation command; and
invalidate a cache of the memory device based on receiving the invalidation command, wherein the translation table is stored in the cache.
12. The die of any of clauses 10-11, wherein the memory address is a physical memory address of a device.
13. The die of any of clauses 10-12, wherein the memory address is of a memory page table.
14. The die of any of clauses 10-13, wherein the at least one processor is configured to:
extract, from the address translation request, a memory page address and a memory page offset value; and
determine the memory address for the translation table based on the memory page address and the memory page offset value.
15. The die of any of clauses 10-14, wherein the at least one processor is configured to receive the address translation request from a client device, and transmit the memory address to the client device.
16. The die of any of clauses 10-15, wherein the memory address is a first memory address, and wherein the at least one processor is configured to:
read a second memory address from a second translation table based on the first memory address; and
transmit the second memory address in response to the address translation request.
17. A system-on-chip, comprising:
first memory address translation logic; and
memory management logic electrically coupled to the first memory address translation logic, wherein the first memory address translation logic is configured to:
receive, from the memory management logic, a first address translation request comprising a virtual memory address;
read a first memory address from a first translation table based on the virtual memory address;
transmit the first memory address to the memory management logic, wherein the memory management logic is configured to generate a physical memory address based on the first memory address.
18. The system-on-chip of clause 17, wherein the first memory address is the physical memory address.
19. The system-on-chip of clause 17 comprising second memory address translation logic, wherein the second memory address translation logic is configured to:
receive, from the memory management logic, a second address translation request comprising the first memory address;
read a second memory address from a second translation table based on the first memory address; and
transmit the second memory address to the memory management logic, wherein the memory management logic is configured to generate the physical memory address based on the second memory address.
20. The system-on-chip of any of clauses 17-19 comprising an interface bus, wherein the memory management logic is configured to receive the virtual memory address from a client device over the interface bus, and transmit the physical memory address to the client device over the interface bus.
21. The system-on-chip of any of clauses 17-20, wherein the first memory address translation logic is configured to:
extract, from the first address translation request, a memory page address and a memory page offset value; and
determine the first memory address for the first translation table based on the memory page address and the memory page offset value.
22. The system-on-chip of any of clauses 17-21 comprising a memory device, wherein the first memory address translation logic is positioned within the memory device, the memory device storing the first translation table.
23. The system-on-chip of any of clauses 17-21, wherein an off-chip memory device stores the first translation table.
24. The system-on-chip of any of clauses 17-23 comprising second memory address translation logic, wherein the second memory address translation logic is configured to:
receive, from the first memory address translation logic, a second address translation request comprising the first memory address;
read a second memory address from a second translation table based on the first memory address;
transmit the second memory address to the first memory address translation logic, wherein the first memory address translation logic is configured to generate the first memory address based on the second memory address.
25. The system-on-chip of any of clauses 17-24 comprising a memory channel, wherein the memory management logic is configured to communicate with the first memory address translation logic over the memory channel.
26. The system-on-chip of clause 25, where the memory channel is a Low Power Double Data Rate channel.
27. The system-on-chip of any of clauses 24-26, wherein the memory management logic is configured to transmit a command to the first memory address translation logic over the memory channel.

Although the methods described above are with reference to the illustrated flowcharts, many other ways of performing the acts associated with the methods may be used. For example, the order of some operations may be changed, and some embodiments may omit one or more of the operations described and/or include additional operations.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code that, when executed, causes a machine to fabricate at least one integrated circuit that performs one or more of the operations described herein. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for causing a machine to fabricate the integrated circuit. The methods may also be at least partially embodied in the form of a computer into which computer program code is loaded or executed, such that, the computer becomes a special purpose computer for causing a machine to fabricate the integrated circuit. For instance, when implemented on a general-purpose processor, computer program code segments can configure the processor to create specific logic circuits. The methods may alternatively be at least partially embodied in application specific integrated circuits or any other integrated circuits for performing the methods.

In addition, terms such as “circuit,” “circuitry,” “logic,” and the like can include, alone or in combination, analog circuitry, digital circuitry, hardwired circuitry, programmable circuitry, processing circuitry, hardware logic circuitry, state machine circuitry, and any other suitable type of physical hardware components. Further, the embodiments described herein may be employed within various types of devices such as networking devices, telecommunication devices, smartphone devices, gaming devices, enterprise devices, storage devices (e.g., cloud storage devices), and computing devices (e.g., cloud computing devices), among other types of devices.

The subject matter has been described in terms of exemplary embodiments. Because they are only examples, the claimed inventions are not limited to these embodiments. Changes and modifications may be made without departing the spirit of the claimed subject matter. It is intended that the claims cover such changes and modifications.

1. A die comprising:
translation control logic; and
memory address translation logic electrically coupled to the translation control logic, the memory address translation logic configured to:
receive an address translation request comprising a virtual memory address from the translation control logic;
read a translation table from a memory device, wherein the translation control logic is positioned between the memory address translation logic and the memory device;
read a memory address from the translation table based on the virtual memory address; and
transmit the memory address to the translation control logic.

2. (canceled)

3. The die of claim 1, wherein the memory address translation logic is configured to:
receive an invalidation command; and
invalidate a cache of the memory device based on receiving the invalidation command, wherein the translation table is stored in the cache.

4. (canceled)

5. The die of claim 1, wherein the memory address is a physical memory address of a device.

6. The die of claim 1, wherein the memory address is of a memory page table.

7. The die of claim 1, wherein the memory address translation logic is configured to:
extract, from the address translation request, a memory page address and a memory page offset value; and
determine the memory address for the translation table based on the memory page address and the memory page offset value.

8. The die of claim 1, wherein the translation control logic is configured to receive the address translation request from a client device, and transmit the memory address to the client device.

9. The die of claim 1, wherein the translation control logic is configured to:
receive the memory address from the memory address translation logic;
read a second memory address from a second translation table based on the memory address; and
transmit the second memory address to a client device.

10. A die comprising:
an interface bus;
a memory device; and
at least one processor electrically coupled to the memory device, the at least one processor configured to:
receive an address translation request comprising a virtual memory address received from a client device over the interface bus;
read a memory address from a translation table stored in the memory device based on the virtual memory address; and
transmit the memory address in response to the address translation request to the client device over the interface bus.

11. The die of claim 10, wherein the at least one processor is configured to:
receive an invalidation command; and
invalidate a cache of the memory device based on receiving the invalidation command, wherein the translation table is stored in the cache.

12. The die of claim 10, wherein the memory address is a first memory address, and wherein the at least one processor is configured to:
read a second memory address from a second translation table based on the first memory address; and
transmit the second memory address in response to the address translation request.

13. A system-on-chip, comprising:
a memory device configured to store a first translation table;
first memory address translation logic positioned within the memory device; and
memory management logic electrically coupled to the first memory address translation logic, wherein the first memory address translation logic is configured to:
receive, from the memory management logic, a first address translation request comprising a virtual memory address;
read a first memory address from the first translation table based on the virtual memory address; and
transmit the first memory address to the memory management logic, wherein the memory management logic is configured to generate a physical memory address based on the first memory address.

14. The system-on-chip of claim 13 comprising a second memory address translation logic, wherein the second memory address translation logic is configured to:
receive, from the memory management logic, a second address translation request comprising the first memory address;
read a second memory address from a second translation table based on the first memory address; and
transmit the second memory address to the memory management logic, wherein the memory management logic is configured to generate the physical memory address based on the second memory address.

15. The system-on-chip of claim 13 comprising an interface bus, wherein the memory management logic is configured to receive the virtual memory address from a client device over the interface bus, and transmit the physical memory address to the client device over the interface bus.

16. (canceled)

17. The system-on-chip of claim 13, wherein an off-chip memory device stores the first translation table.

18. The system-on-chip of claim 13 comprising second memory address translation logic, wherein the second memory address translation logic is configured to:
receive, from the first memory address translation logic, a second address translation request comprising the first memory address;
read a second memory address from a second translation table based on the first memory address; and
transmit the second memory address to the first memory address translation logic, wherein the first memory address translation logic is configured to generate the first memory address based on the second memory address.

19. The system-on-chip of claim 13 comprising a memory channel, wherein the memory management logic is configured to communicate with the first memory address translation logic over the memory channel.

20. system-on-chip of claim 19, wherein the memory management logic is configured to transmit a command to the first memory address translation logic over the memory channel.
